(19) United States
(12) Patent Application Publication
(10) Pub. No.: US 2007/0210126 A1
(43) Pub. Date: Sep. 13, 2007

(54) Sweater basket

(75) Inventors: Donald S. Hanson, Evans, GA (US); John Herrick, Evans, GA (US); Bradley J. Hanson, North Augusta, SC (US); Kent H. Bruntz, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/369,918

(22) Filed: Mar. 7, 2006

(51) Int. Cl. B60R 9/00

(52) U.S. Cl. 224/274

(57) ABSTRACT

A one-piece molded golf car basket generally mounted to the golf car behind the golf car seat. The basket includes an integrally formed front wall, two integrally formed opposing side walls, an integrally formed back wall and an integrally formed bottom. Additionally, the basket includes a golf bag yoke integrally formed with the back wall.

### FIELD

The present disclosure relates generally to golf cars and to golf car basket with integral golf bag retainers formed therein.

### BACKGROUND

The statements in this section merely provide background information related to the present disclosure and may not constitute prior art.

Generally, known golf car utility baskets, also referred to as sweater baskets, are constructed of coated wire that forms a wire mesh basket. The wire mesh sweater baskets are typically mounted to the back of the golf car seat, canopy struts, or other framework behind the golf car seat. Additionally, known golf cars typically have a golf bag retaining harness or yoke that is bolted, or otherwise coupled, to the sweater basket.

Wire sweater baskets are expensive to manufacture and can be easily dented or deformed. Additionally, such known sweater baskets generally require additional hardware or brackets to attach the golf bag yoke and other accessories, such as sand bucket and/or drink cooler holders. Such multiple piece assembly adds parts and labor costs to the golf car.

### SUMMARY

A one-piece molded golf car basket. The basket is generally mounted to the golf car behind the seat and includes an integrally formed front wall, two integrally formed opposing side walls, an integrally formed back wall and an integrally formed bottom. In various embodiments, the basket includes a divider wall integrally formed with the bottom that substantially divides the basket into two compartments. Additionally, in various embodiments the basket includes a golf bag yoke integrally formed with the back wall.

The basket bottom includes a plurality of elongated apertures and a plurality of cross members therebetween. The cross members have an arched upper surface adapted to prevent dust, water and debris from collecting in the basket bottom. In various embodiments, the bottom is formed to have an arched contour as the bottom extends between the side walls and/or an arched contour as the bottom extends between the front wall and the back wall. Furthermore, in some embodiments, the back wall includes a stiffening channel integrally formed along a top edge of the back wall whereby the stiffening channel forms at least a portion of the golf bag yoke. The stiffening channel includes a rake hole for retaining a rake handle. In various embodiments, the rake hole comprises a cylindrical aperture having a detent integrally formed within a wall of the cylindrical aperture. The detent is adapted for positioning a rake handle stud therewithin to prevent the rake handle from spinning when retained within the cylindrical aperture.

Further areas of applicability will become apparent from the detailed description provided hereinafter. It should be understood that the detailed description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is side view of a golf car in accordance with various embodiments;

FIG. 2 is an isometric view of a golf car basket shown in FIG. 1, in accordance with various embodiments;

FIG. 3 is a rear view of the golf car basket shown in FIG. 2;

FIG. 4 is a top view of the golf car basket shown in FIG. 2; and

FIG. 5 is a sectional view of a yoke integrally formed with the basket shown in FIG. 2 illustrating a rake hole integrally formed in the yoke.

### DETAILED DESCRIPTION

The following description is merely exemplary in nature and is in no way intended to limit the present disclosure, its application or uses. Throughout this specification, like reference numerals will be used to refer to like elements.

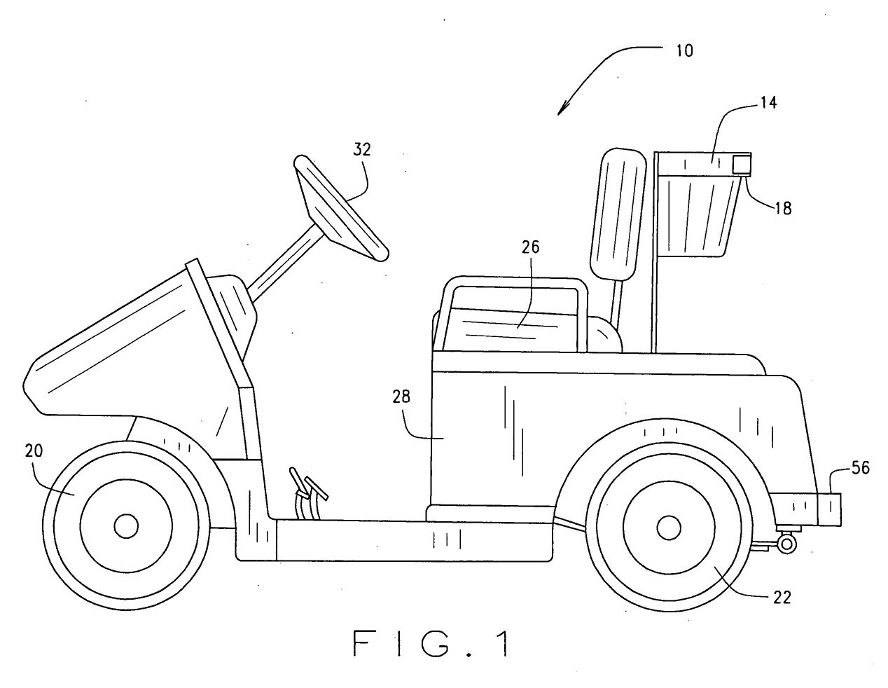

FIG. 1 illustrates a golf car 10 including a golf car basket 14, sometimes referred to a sweater basket, in accordance with the various embodiments. The basket 14 is utilized for holding a golfer's personal items and/or golfing equipment, such as golf balls, club covers, gloves, hats, jackets, sweaters, shoes, etc. Additionally, as described in detail below, the basket 14 is a one-piece structure including a golf bag yoke 18 integrally formed therein for securing a golf bag (not shown) to the golf car 10. The golf car 10 additionally includes a pair of front wheels 20 that operate to steer the golf car 10 and a pair of rear wheels 22, wherein at least one of the rear wheels 22 functions as a drive wheel for propelling golf car 10. The golf car 10 further includes a driver's seat 26 to accommodate a driver and a passenger's seat (not shown) that accommodates a passenger. The driver's seat 26 and passenger's seat can be combined to form a single bench type seat mounted to a seat base 28 of the golf car 10. Alternatively, the driver's seat 26 and the passenger's seat can be independent seats mounted side-by-side on the seat base 28. The golf car 10 also includes a steering wheel 32 which controls a steering angle of the front wheels 20.

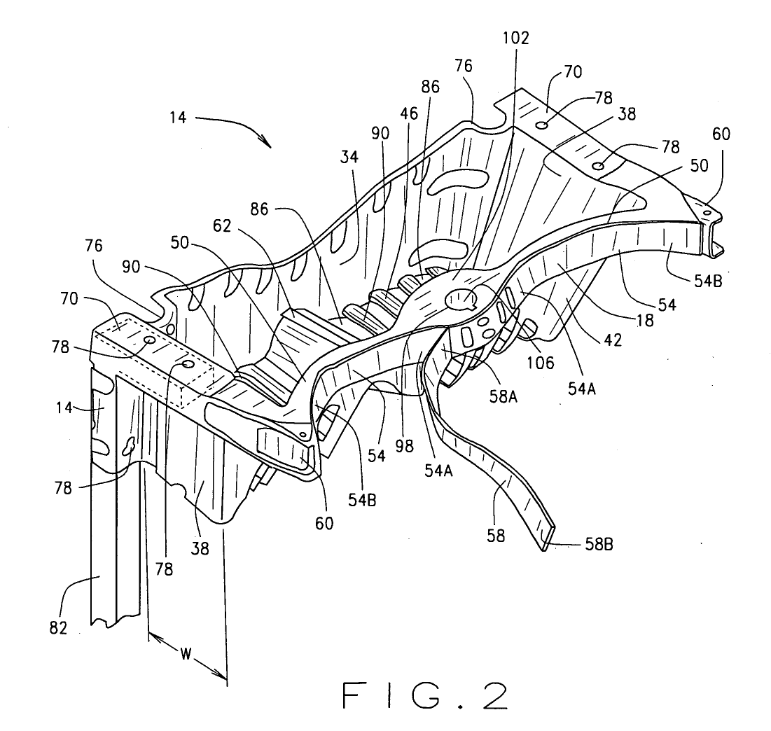

Referring to FIGS. 2, 3 and 4, the basket 14 is a one-piece structure, for example, a molded plastic one-piece structure, that includes a front wall 34, two opposing sidewalls 38, a back wall 42 and bottom 46 integrally formed together to form the basket 14. The basket 14 further includes a stiffening channel 50 integrally formed along a top edge of the back wall 42. The stiffening channel 50 provides rigidity and support to the back wall 42. In at least one embodiment, the stiffening channel 50 includes a plurality of ribs, or intercostals, that span an interior portion of the stiffening channel 50 to provide additional rigidity and structural strength to the stiffening channel 50 and the golf bag yoke 18. Additionally, the stiffening channel 50 forms at least a portion of the golf bag yoke 18. The yoke 18 includes one or more curved sections 54 for generally retaining a golf bag (not shown) within each curved section 54.

To secure a golf bag to the golf car 10, or more specifically to the yoke 18, the golf bag is placed on a cargo platform 56 (shown in FIG. 1) and rested against the yoke 18 within a curved section 54. A retaining strap 58 connected at a fixed end 58A to a first end portion 54A of the curved section 54 is placed around the golf bag and a free end 58B threaded into a securing clip 60. The securing clip 60 is mounted to a back side of the yoke 18 at a second end 54B of the curved section 54. Once the free end 58B is threaded through the securing clip 60, the retaining strap can be pulled tight around the golf bag to firmly press the golf bag against the yoke 18. The securing clip 60 is then positioned to hold the retaining strap 58 therewithin such that the golf bag is secured to the yoke 18 and the golf car 10. For clarity of illustration, only one retaining strap 58 is shown in FIG. 2. However, it should be understood that a second retaining strap 58 would be connected to the first end portion 54A of the other curved section 54 shown in FIG. 2.

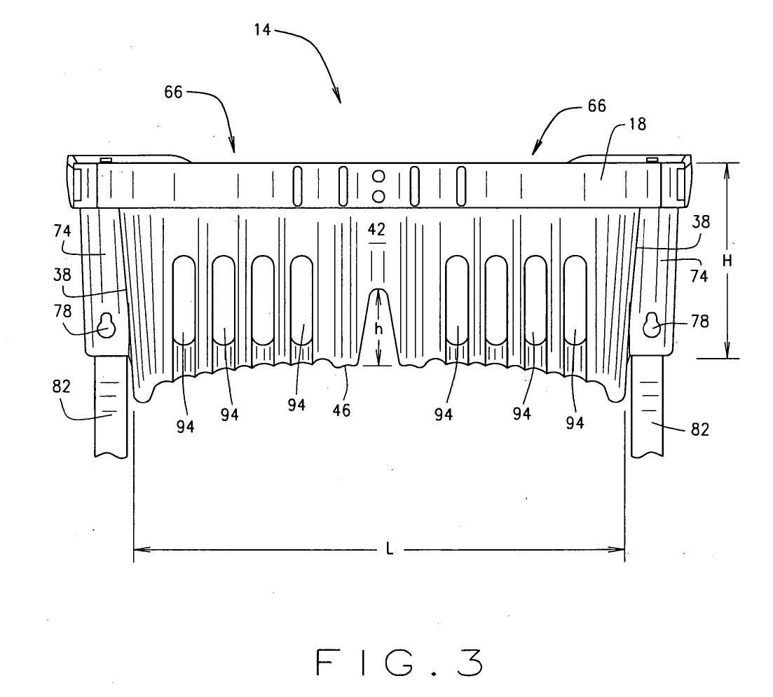

In various embodiments, the basket 14 includes a divider wall 62 integrally formed with the basket bottom 46 that substantially divides the basket 14 into two compartments 66. The divider wall 62 can have any suitable height h, shown in FIG. 3, to desirably divide the basket 14 into the two compartments 66. For example, the height h of the divider wall 62 can be approximately equal to one fourth, one half, substantially equal to a height H of the back wall 42. The compartments allow the separation of the equipment and personal items that may be placed in the basket 14. For example, if two golfers are utilizing the basket 14, the equipment and personal items of each golfer can be separated into the separate compartments 66 within the basket 14. Or, one compartment 66 can be used to store golf equipment, e.g. golf balls, head covers, etc., and the other compartment 66 can be used to store and keep separate personal items, e.g., hats, gloves, sweaters, shoes, etc.

The basket 14 additionally includes pockets 70 integrally formed along an upper edge of the side walls 38 and flanges 74 integrally formed at the corners of the basket 14 joining the back wall 34 and the side walls 38. The pockets 70 and flanges 74 include holes 78 for securing the basket 14 to structural supports, or struts, 82 of the golf car 10. Any suitable fastening means can be used in combination with the holes 78 to fasten the basket 14 to the struts 82, for example, screws, rivets, push pins or nut and bolt fasteners. More particularly, the pockets 70 and flanges 74 are adapted to conceal the portion of the struts 82 used to support and mount the basket 14. This avoids the unpleasant appearance of the struts 82 along the top edge and back sides of the basket side walls 38 and provides an overall aesthetically pleasing appearance to the basket 14. To further provide an overall aesthetically pleasing appearance to the basket 14, the back wall 43 has integrally formed therein canopy support channels 76. If the golf car 10 is equipped with a canopy, the canopy support channels 76 substantially conceal the portions of canopy supports (not shown) that are adjacent the canopy struts.

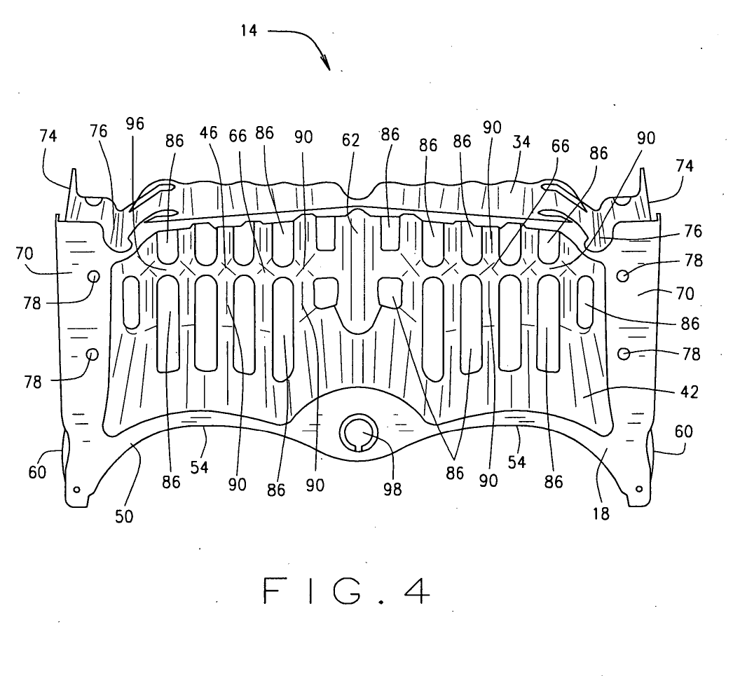

Referring now to FIGS. 3 and 4, the basket 14 includes a plurality of apertures 86 and a plurality of cross members 90 formed between the apertures 86. The apertures 86 are sized so that equipment and personal items placed in the basket 14 do not fall through the apertures 86, but generally all dirt, sand, water and other debris will fall or flow through the apertures 86. As most clearly seen in FIG. 2, the cross members 90 each have an arched upper surface so that water, sand, dirt, and any other debris will be inclined to slide, roll or flow off the arched upper surfaces and through the apertures 86. Therefore, the water, sand, dirt and other debris will not easily settle and built up within the basket 14. Additionally, the apertures 86 and the arched upper surfaces of the cross members 90 allow the basket 14 to be easily cleaned by merely spraying the basket 14 out with water or compressed air.

In various embodiments, the apertures 86 are elongated oval apertures, as illustrated in FIGS. 2, 3, and 4. However, the apertures 86 could have any suitable shape, such as rectangular, square, round, triangular, etc. Additionally, as shown in FIG. 4, in some embodiments, the apertures 86 are elongated apertures that extend along the bottom 46 and a portion of the way up the back wall 42. In other various embodiments, the apertures 86 are elongated apertures that extend along the bottom 46 and a portion of the way up the front wall 34. In still other embodiments, the back wall 42 and/or the front wall 34 include a plurality of apertures 94 that are separate from the apertures 86, most clearly shown in FIG. 3. Both the elongated apertures 86 that extend up the back wall 42 and/or the front wall 34, and the separate apertures 94 in the back wall 42 and/or the front wall 34, add to the nature of the basket 14 to resist collecting water, sand, dirt and other debris and the ease of cleaning by merely spraying the basket 14 out with water or compressed air.

Referring particularly to FIG. 3, the basket bottom 46 is formed to have an arched shape or contour across a length L extending between the sides walls 38. Particularly, the arched bottom 46 would be respectively higher in the middle near the divider wall 62 and slope or arch downward toward the side walls 38. Therefore, water, dirt, sand and debris inside the basket 14 would have a tendency to blow, roll or flow toward the side walls 38 and fall or flow through the apertures 86.

Referring now to FIG. 2, in various embodiments, the basket bottom 46 is formed to have an arched shape or contour across a width W extending between the front and back walls 34 and 42. Particularly, the arched bottom 46 would be respectively higher in the middle of the width W and slope or arch downward toward the front and back walls 34 and 42. Therefore, water, dirt, sand and debris inside the basket 14 would have tendency to blow, roll or flow toward the front and back walls 34 and 42, and fall or flow through the apertures 86.

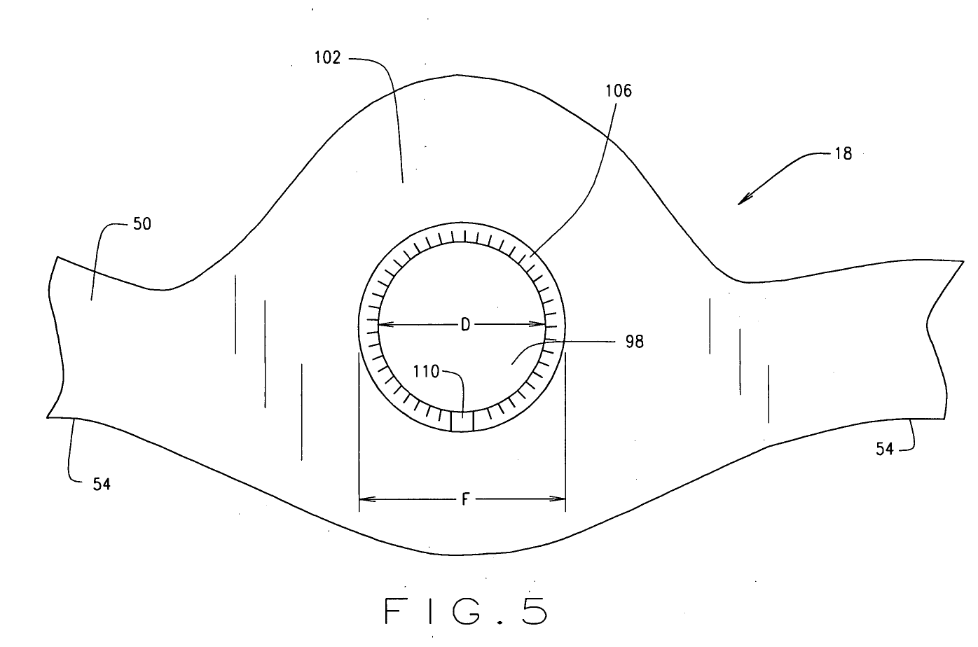

Referring to FIGS. 2, 4 and 5, as described above, the back wall 42 includes the stiffening channel 50 integrally formed along the top edge of the back wall 42 and forming at least a portion of the golf bag yoke 18. The golf bag yoke 18 and, thus, the stiffening channel 50, includes a rake hole 98 integrally formed in a top surface 102 of the golf bag yoke 18 and stiffening channel 50. The rake hole 98 is adapted to accommodate a handle of a rake (not shown) and retain the rake handle so that the rake can be stored on the golf car 10 and removed for use when desired. In various embodiments, the rake hole 98 comprises a cylindrical aperture integrally formed within the golf bag yoke 18 and, thus, within the stiffening channel 50. The cylindrical rake aperture 98 includes a wall 106. The cylindrical rake aperture 98 additionally includes a detent 110, i.e., channel, slot or recess, integrally formed in the wall 106 and adapted to receive a stud, e.g., post, pin, button, screw, etc., connected to, or formed in, the rake handle. Therefore, when the rake handle is retained within the cylindrical rake aperture 98 and the stud is positioned within the detent 110, the rake handle is substantially prevented from spinning within the cylindrical rake aperture 98. The detent 110 can be formed to extend along the entire length of the cylindrical rake aperture wall 106, or any portion of the wall length. Additionally, in some embodiments, the cylindrical rake aperture wall 106 has a slightly conical form such that a diameter D of the opening at the bottom of the wall 106 is slightly smaller than a diameter F of the opening at the top of the wall 106 formed in the top surface 102.

Therefore, the basket 14 is a one-piece structure having integrally formed therein the golf bag yoke 18 and the divider 62. To provide easy cleaning and maintenance, the basket 14 includes the apertures 86 and the cross members 90 that have a rounded or arched top or upper surface to prevent dust, water and debris from collecting in the basket bottom 46. To further add to the ease of cleaning and maintenance of the basket 14, the bottom 46 is formed to have an arched contour as the bottom extends between the side walls 38 and/or-an arched contour as the bottom extends between the front wall 34 and the back wall 42. The one-piece basket 14 additionally includes the cylindrical rake aperture 98 that includes the detent 110 for retaining a rake handle and preventing the rake from spinning within the rake aperture 98. Furthermore, the one-piece basket 14 is adapted to provide an aesthetically pleasing appearance by having integrally formed therewith the pockets 70 and flanges 74 that conceal the portion of the struts 82 used to support and mount the basket 14.

The description herein is merely exemplary in nature and, thus, variations that do not depart from the gist of that which is described herein are intended to be within the scope of the disclosure. Such variations are not to be regarded as a departure from the spirit and scope of the disclosure.

What is claimed is:

1. A basket for a golf car, said basket comprising a one-piece molded body having a front wall, two opposing side walls, a back wall and a bottom that form a basket, wherein the back wall includes a golf bag yoke integrally formed therein.

2. The basket of claim 1, wherein the bottom includes a divider wall integrally formed therein that substantially divides the basket into two compartments.

3. The basket of claim 1, wherein the back wall further includes a stiffening channel integrally formed along a top edge of the back wall that forms at least a portion of the golf bag yoke.

4. The basket of claim 1, wherein the bottom includes a plurality of apertures and a plurality of cross members therebetween.

5. The basket of claim 4, wherein each cross member includes an arched upper surface.

6. The basket of claim 1, wherein the bottom is formed to include at least one of:
an arched contour as the bottom extends between the side walls; and
an arched contour as the bottom extends between the front wall and the back wall.

7. The basket of claim 1, wherein the golf bag yoke includes a rake hole for retaining a rake handle therewithin.

8. The basket of claim 7, wherein the rake hole comprises a cylindrical aperture integrally formed within the golf bag yoke.

9. The basket of claim 8, wherein the cylindrical aperture includes a wall having a detent integrally formed therein for positioning a rake handle stud therewithin to prevent the rake handle from spinning when retained within the cylindrical aperture.

10. A basket for a golf car, said basket comprising:
a one-piece molded body having a front wall, two opposing side walls, a back wall and a bottom that form a basket: and
a divider wall integrally formed with the bottom that substantially divides the basket into two compartments.

11. The basket of claim 10, wherein the back wall includes a golf bag yoke integrally formed therein.

12. The basket of claim 10, wherein the bottom includes a plurality of apertures and a plurality of cross members therebetween, the cross members having an arched upper surface.

13. The basket of claim 10, wherein the bottom is formed to include at least one of
an arched contour as the bottom extends between the side walls; and
an arched contour as the bottom extends between the front wall and the back wall.

14. The basket of claim 10, wherein the golf bag yoke comprises a cylindrical aperture integrally formed therein for retaining a rake.

15. The basket of claim 14, wherein the cylindrical aperture includes a wall having a detent integrally formed therein for positioning a rake handle stud therewithin to prevent the rake handle from spinning when retained within the cylindrical aperture.

16. A golf bag retaining system comprising:
a golf bag yoke integrally formed with a golf car basket, the yoke including at least one curved section for resting a golf bag therewithin;
a retaining strap connected at a fixed end to a first end portion of the curved section; and
a securing clip pivotally mounted within a C-channel integrally formed in a back side of the yoke at a second end of the curved section for retaining a free end of the retaining strap to securely retain a golf bag within the curved section of the yoke.

17. A golf car comprising:
a seat suitable for accommodating a golf car driver;
a one-piece molded basket mounted to the golf car behind the seat, the basket including:
a front wall, two opposing side walls, a back wall and a bottom;
a divider wall integrally formed with the bottom that substantially divides the basket into two compartments; and
a golf bag yoke integrally formed with the back wall.

18. The golf car of claim 17, wherein the bottom includes a plurality of apertures and a plurality of cross members therebetween, the cross members having an arched upper surface.

19. The golf car of claim 17, wherein the bottom is formed to include at least one of
an arched contour as the bottom extends between the side walls; and
an arched contour as the bottom extends between the front wall and the back wall.

20. The basket of claim 17, wherein the back wall includes a stiffening channel integrally formed along a top edge of the back wall that forms at least a portion of the golf bag yoke, the stiffening channel including a rake hole for retaining a rake, the rake hole comprising a cylindrical aperture including a wall having a detent integrally formed therein for positioning a rake handle stud therewithin to prevent the rake handle from spinning when retained within the cylindrical aperture.
